(19) United States
(12) Patent Application Publication
(10) Pub. No.: US 2013/0241845 A1
(43) Pub. Date: Sep. 19, 2013

(54) TOUCH PANEL

(71) Applicants: Chao-Yong Hsu, Changhua County (TW); Shih-Hung Huang, Taoyuan County (TW); Hung-Hsiang Chen, Taoyuan County (TW)

(72) Inventors: Chao-Yong Hsu, Changhua County (TW); Shih-Hung Huang, Taoyuan County (TW); Hung-Hsiang Chen, Taoyuan County (TW)

(21) Appl. No.: 13/528,795

(22) Filed: Jun. 20, 2012

(30) Foreign Application Priority Data
Mar. 14, 2012 (TW) 101108694

(51) Int. Cl. G06F 3/041

(52) U.S. Cl. 345/173

(57) ABSTRACT

A touch panel includes a plurality of first axis electrodes and a plurality of second axis electrodes. The first axis electrodes extend along a first direction and the first axis electrodes are disposed repeatedly along a second direction. Each of the first axis electrodes includes a plurality of first sensing electrodes disposed along the first direction. The second axis electrodes extend along the second direction and the second axis electrodes are disposed repeatedly along the first direction. Each of the second axis electrodes surrounds the first sensing electrodes disposed along the second direction.

### BACKGROUND OF THE INVENTION

1. Field of the Invention

The present invention relates to a touch panel, and more particularly, to a touch panel having a high signal to noise ratio (SNR) and a high signal sensing density by modifying shapes and allocations of different axis electrodes.

2. Description of the Prior Art

Since touch sensing technologies may be employed to improve human-computer interaction, electronic products, which have both the touch sensing function and the display function, are commercialized in recent years. There are many diverse technologies of touch panel, and the resistance touch technology, the capacitive touch technology and the optical touch technology are the main touch technologies in use. The capacitive touch technology has become the mainstream touch technology for the high-end and the mid-end consumer electronics, because the capacitive touch panel has advantages such as high precision, multi-touch property, better endurance, and higher touch sensing resolution.

In the capacitive touch technology, transparent sensing electrodes are used to detect the variations of electrical capacitances around a touch point, and feedback signals are transmitted via connecting lines, which interconnect all of the transparent sensing electrodes along different axis directions to locate the touch points. Please refer to FIG. 1. FIG. 1 is a schematic diagram illustrating a conventional capacitive touch panel. As shown in FIG. 1, a conventional capacitive touch panel 100 includes a plurality of first axis electrodes 110 and a plurality of second axis electrodes 120. Each of the first axis electrodes 110 extends along a first direction X and the first axis electrodes 110 are repeatedly disposed along a second direction Y. Each of the second axis electrodes 120 extends along the second direction Y and the second axis electrodes 120 are repeatedly disposed along the first direction X. Each of the first axis electrodes 110 includes a plurality of first sensing electrodes 111 and a plurality of first connecting lines 112. The first sensing electrodes 111 and the first connecting lines 112 are aligned along the first direction X, and each of the first connecting lines 112 is used to electrically connect two adjacent first sensing electrodes 111 in the first direction X. Each of the second axis electrodes 120 includes a plurality of second sensing electrodes 121 and a plurality of second connecting lines 122. The second sensing electrodes 121 and the second connecting lines 122 are aligned along the second direction Y, and each of the second connecting lines 122 is used to electrically connect two adjacent second sensing electrodes 121 in the second direction Y. In other words, the first axis electrodes 110 are disposed interlacedly with the second axis electrodes 120. A shape of the first sensing electrode 111 is generally identical to a shape of the second sensing electrode 121. For example, the first sensing electrode 111 and the second sensing electrode 121 are generally rhombus electrodes. The first sensing electrodes 111 and the second sensing electrodes 121 are disposed alternately and uniformly in the conventional capacitive touch panel 100.

Under a mutual capacitive operation mode of the conventional capacitive touch panel 100, touch driving signals TX are respectively applied to each of the first axis electrodes 110 by scanning Coupling capacitance effects may occur between the first sensing electrodes 111 and the second sensing electrodes 121, and touch receiving signals RX may be obtained from each of the second axis electrodes 120. The touch receiving signals RX may decline when a conductive touch object such as a human finger touches the conventional capacitive touch panel 100 because another coupling path may be generated to absorb some electrical charge due to the conductibility and the lower electrical potential of the human finger. The actual touch point may be figured out by calculating the variation of the touch receiving signals RX. Each of the first sensing electrodes 111 and each of the second sensing electrodes 121 must have specific areas to induce required coupling capacitance effect with the touch object. However, a parasitic capacitance between the first sensing electrode 111 and the second sensing electrode 121 may also be accordingly increased to interfere with the touch signals. In addition, under the structure of the conventional capacitive touch panel 100, the areas of each of the first sensing electrodes 111 and each of the second sensing electrodes 121 have to be shrunk for increasing the signal sensing density and the touch sensing resolution. However, the coupling capacitance effect may also be reduced and the touch sensitivity may be affected by reducing areas of each of the first sensing electrodes 111 and each of the second sensing electrodes 121. Generally, the first sensing electrodes 111 and the second sensing electrodes 121 are made of transparent conductive materials such as indium tin oxide (ITO) which is a material with high refractive index and may still absorb some light. Therefore, a visual difference may be generated between a region with the sensing electrodes and a region without the sensing electrodes, an issue of visible sensing electrodes may occur, and an appearance quality of the touch panel may accordingly be affected.

### SUMMARY OF THE INVENTION

It is one of the objectives of the present invention to provide a touch panel. Shapes and allocations of different axis electrodes are modified. Electrodes extending along one axis are disposed to surround sensing electrodes of electrodes extending along another axis. A signal to noise ratio (SNR) and a signal sensing density of the touch panel may be accordingly enhanced.

To achieve the purposes described above, a preferred embodiment of the present invention provides a touch panel. The touch panel includes a plurality of first axis electrodes and a plurality of second axis electrodes. The first axis electrodes extend along a first direction and the first axis electrodes are disposed repeatedly along a second direction. Each of the first axis electrodes includes a plurality of first sensing electrodes disposed along the first direction. The second axis electrodes extend along the second direction and the second axis electrodes are disposed repeatedly along the first direction. Each of the second axis electrodes surrounds the first sensing electrodes disposed along the second direction.

Another preferred embodiment of the present invention provides a touch panel. Each of the second axis electrodes has a plurality of hollow regions disposed along the second direction, and each of the first sensing electrodes is disposed in the hollow region.

Another preferred embodiment of the present invention provides a touch panel. Each of the first axis electrodes further comprises a plurality of first connecting lines to electrically connect the first sensing electrodes within one identical first axis electrode and transmit a touch driving signal, and a touch receiving signal is received from each of the second axis electrodes.

Another preferred embodiment of the present invention provides a touch panel. The touch panel further comprises a plurality of third axis electrodes extending along the first direction. The third axis electrodes are disposed repeatedly along the second direction, and each of the third axis electrodes is disposed between two adjacent first axis electrodes.

Another preferred embodiment of the present invention provides a touch panel. Each of the third axis electrodes comprises a plurality of second sensing electrodes disposed along the first direction, and each of the second sensing electrodes is disposed between two adjacent second axis electrodes.

Another preferred embodiment of the present invention provides a touch panel. Each of the third axis electrodes further comprises a plurality of second connecting lines to electrically connect the second sensing electrodes within one identical third axis electrodes and transmit a touch driving signal, and a touch receiving signal is received from each of the second axis electrodes.

Another preferred embodiment of the present invention provides a touch panel. The first sensing electrodes, the second sensing electrodes, and the second axis electrodes are made of an identical transparent conductive material.

Another preferred embodiment of the present invention provides a touch panel. An area of the first sensing electrodes and the second sensing electrodes is larger than an area of the second axis electrodes.

Another preferred embodiment of the present invention provides a touch panel. Each of the first axis electrodes is electrically isolated from each of the third axis electrodes.

Another preferred embodiment of the present invention provides a touch panel. At least one of the first axis electrodes is electrically connected to one adjacent third axis electrode.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a conventional capacitive touch panel.

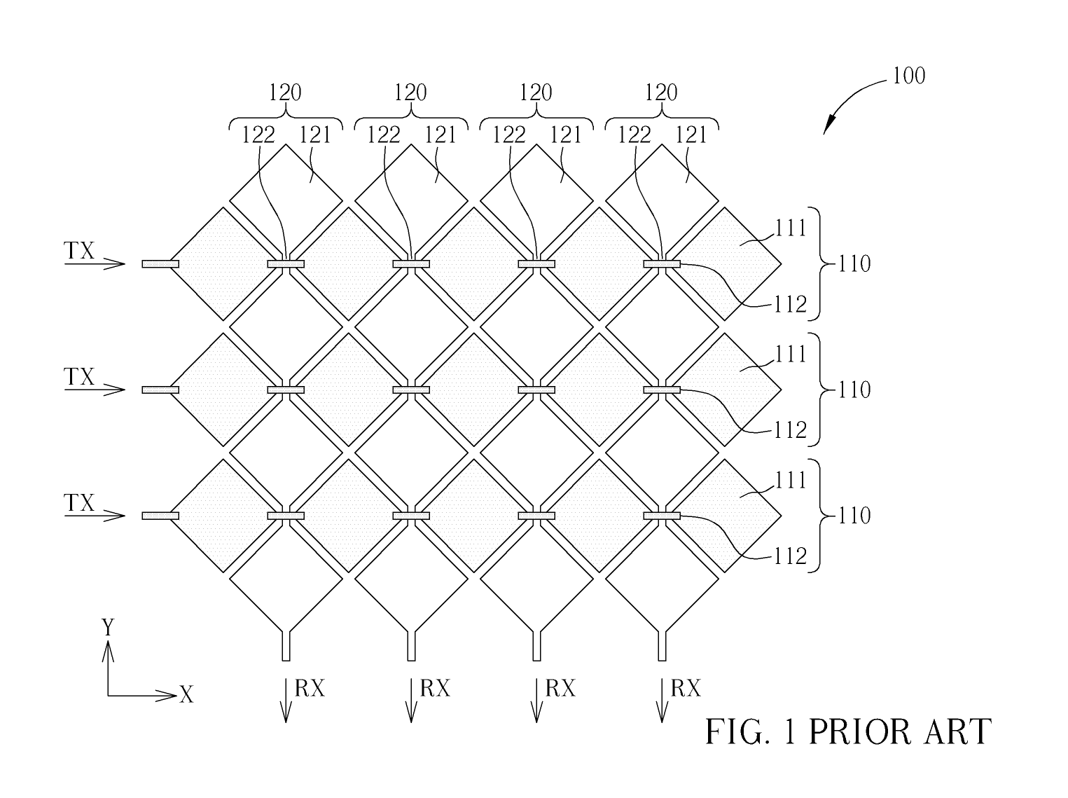

FIG. 2 is a schematic diagram illustrating a touch panel according to a first preferred embodiment of the present invention.

FIG. 3 is a schematic diagram illustrating first sensing electrodes, second sensing electrodes, and second axis electrodes of the touch panel according to the first preferred embodiment of the present invention.

FIG. 4 is a schematic diagram illustrating a touch panel according to a second preferred embodiment of the present invention.

### DETAILED DESCRIPTION

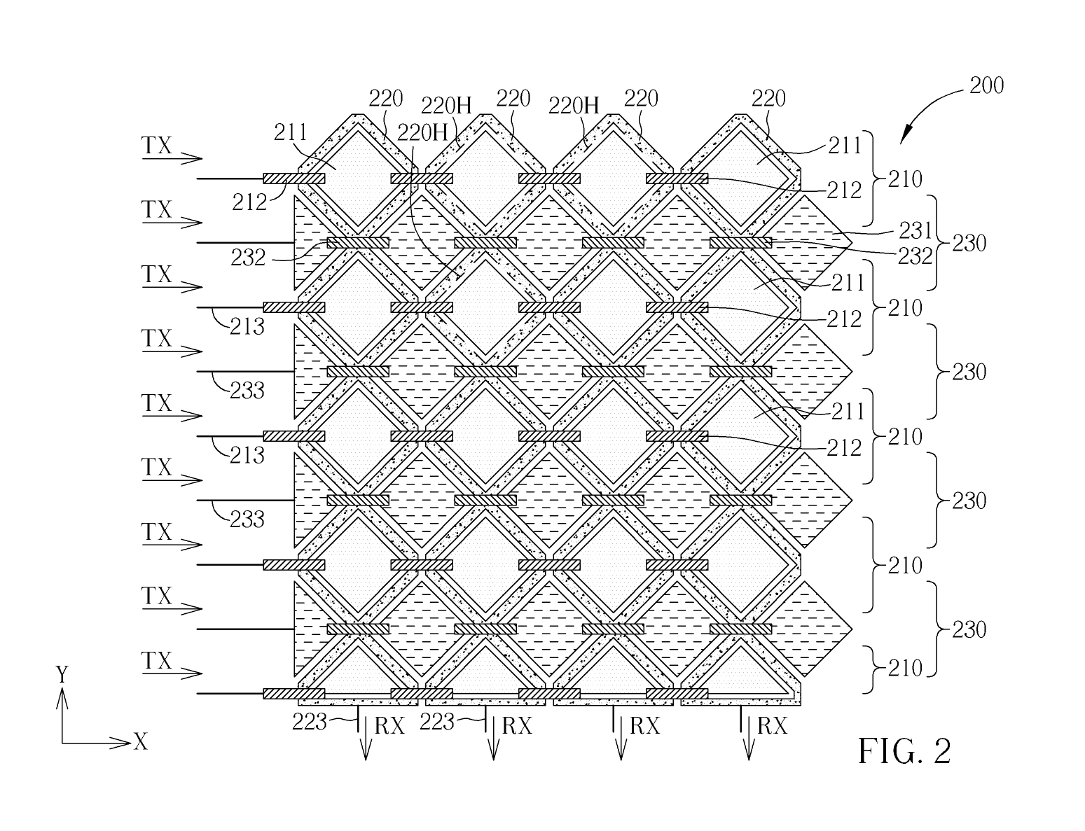

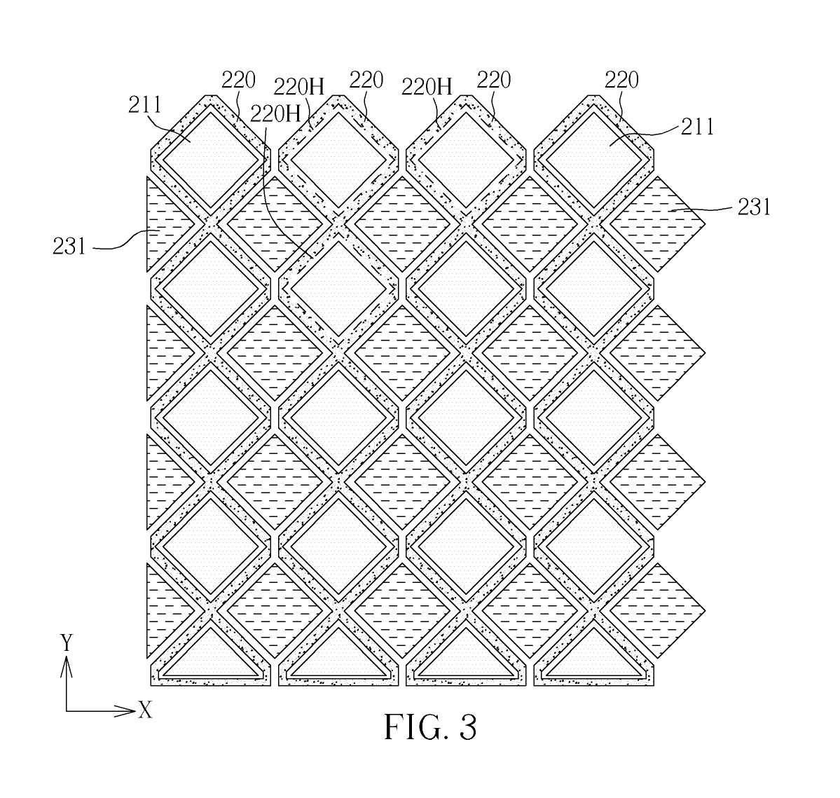

Please refer to FIG. 2 and FIG. 3. FIG. 2 is a schematic diagram illustrating a touch panel according to a first preferred embodiment of the present invention. FIG. 3 is a schematic diagram illustrating first sensing electrodes, second sensing electrodes, and second axis electrodes of the touch panel according to the first preferred embodiment of the present invention. Please note that the figures are only for illustration and the figures may not be to scale. The scale may be further modified according to different design considerations. As shown in FIG. 2 and FIG. 3, the first preferred embodiment of the present invention provides a touch panel 200. The touch panel 200 includes a plurality of first axis electrodes 210 and a plurality of second axis electrodes 220. The first axis electrodes 210 extend along a first direction X and the first axis electrodes 210 are disposed repeatedly along a second direction Y. Each of the first axis electrodes 210 includes a plurality of first sensing electrodes 211 disposed along the first direction X. The second axis electrodes 220 extend along the second direction Y and the second axis electrodes 220 are disposed repeatedly along the first direction X. Each of the second axis electrodes 220 surrounds the first sensing electrodes 211 disposed along the second direction Y. The first direction X is preferably perpendicular to the second direction Y, but not limited thereto. In this embodiment, each of the first axis electrodes 210 may further include a plurality of first connecting lines 212. The first connecting lines 212 may be used to electrically connect the first sensing electrodes 211 within one identical first axis electrode 210 and transmit a touch driving signal TX. A touch receiving signal RX may be received from each of the second axis electrodes 220 by applying the touch driving signal TX to each of the first axis electrodes 210 so as to generate touch positioning effects.

In this embodiment, each of the second axis electrodes 220 has a plurality of hollow regions 220H disposed along the second direction Y, and each of the first sensing electrodes 211 is disposed in the hollow region 220H, but the present invention is not limited to this and the second axis electrode 220 may surround each of the first sensing electrodes 211 by other appropriate approaches. In other words, the second axis electrode 220 in this embodiment may be regarded as a reticulate electrode, but not limited thereto. Additionally, the touch panel 200 may further include a plurality of third axis electrodes 230 extending along the first direction X, and the third axis electrodes 230 are disposed repeatedly along the second direction Y. Each of the third axis electrodes 230 is disposed between two adjacent first axis electrodes 210. In other words, each of the first axis electrodes 210 and each of the third axis electrodes 230 are disposed alternately along the second direction Y, but not limited thereto. Each of the third axis electrodes 230 includes a plurality of second sensing electrodes 231 disposed along the first direction X, and each of the second sensing electrodes 231 is disposed between two adjacent second axis electrodes 220. An area of each of the first sensing electrodes 211 may be equal to an area of each of the second sensing electrodes 231, but not limited thereto. A shape of each of the first sensing electrodes 211 may be identical to a shape of each of the second sensing electrodes 231. For example, the first sensing electrode 211 and the second sensing electrode 231 may be rhombus electrodes, but not limited thereto. Preferably, the first sensing electrodes 211 and the second sensing electrodes 231 are disposed alternately so as to be disposed uniformly in the touch panel 200. In other words, the second axis electrodes 220 are disposed in spacing between each of the first sensing electrodes 211 and each of the second sensing electrodes 231. The first sensing electrodes 211, the second sensing electrodes 231, and the second axis electrodes 220 are preferably made of an identical transparent conductive material, such as indium tin oxide (ITO), indium zinc oxide (IZO), and aluminum zinc oxide (AZO), but not limited thereto. The related appearance defects such as visible electrodes may be accordingly overcome because the second sensing electrodes 231, which are made of the same transparent conductive material, are disposed in the spacing between each of the first sensing electrodes 211 and each of the second sensing electrodes 231.

More specifically, each of the third axis electrodes 230 in this embodiment may further include a plurality of second connecting lines 232. The second connecting lines 232 may be used to electrically connect the second sensing electrodes 231 within one identical third axis electrode 230 and transmit the touch driving signal TX. The touch receiving signal RX may be received from each of the second axis electrodes 220 by applying the touch driving signal TX to each of the third axis electrodes 230. Additionally, the touch panel 200 may further include a plurality of first signal lines 213, a plurality of second signal lines 223, and a plurality of third signal lines 233. Each of the first signal lines 213 is electrically connected to the first axis electrode 210, each of the second signal lines 223 is electrically connected to the second axis electrode 220, and each of the third signal lines 233 is electrically connected to the third axis electrode 230. Additionally, in this embodiment, each of the first signal lines 213 is separated from each of the third signal lines 233, and each of the first axis electrodes 210 may be electrically isolated from each of the third axis electrodes 230 accordingly. In the touch panel 200 of this embodiment, the touch driving signals TX may be sequentially applied to each of the first axis electrodes 210 and each of the third axis electrodes 230 respectively via the first signal lines 213 and the third signal lines 233. The touch driving signals TX may be sequentially applied to each of the first axis electrodes 210 and each of the third axis electrodes 230 by scanning, but not limited thereto. The touch receiving signals RX may be accordingly received from each of the second axis electrodes 220 via the second signal lines 223. It is worth noting that the first sensing electrodes 211 and the second sensing electrodes 231, which are disposed alternately in the touch panel 200, are used to transmit the touch driving signals TX, and the second axis electrodes 220, which are used to received the touch receiving signals RX, are disposed in the spacing between each of the first sensing electrodes 211 and the each of the second sensing electrodes 231. Accordingly, the signal sensing density of the touch panel 200 may be enhanced without changing the areas of the first sensing electrodes 211 and the second sensing electrodes 231. The touch sensing resolution may also be accordingly enhanced. In addition, an area of the first sensing electrodes 211 and the second sensing electrodes 231 is preferably larger than an area of the second axis electrodes 220 so as to lower a parasitic capacitance between the first sensing electrode 211 and the second axis electrode 220, and lower a parasitic capacitance between the second sensing electrode 231 and the second axis electrode 220. Accordingly, a little capacitive variation generated by touch objects (not shown) may be recognized more easily, and a signal to noise ratio (SNR) of the touch panel 200 may be increased. Positioning accuracy and touch sensitivity of the touch panel 200 may also be enhanced.

In this embodiment, the first sensing electrodes 211, the second sensing electrodes 231, and the second axis electrodes 220 are preferably formed by patterning an identical transparent conductive layer, but not limited thereto. The first connecting lines 212, the second connecting lines 232, the first signal lines 213, the second signal liens 223, and the third signal lines 233 preferably include metal materials, such as, aluminum (Al), copper (Cu), silver (Ag), chromium (Cr), titanium (Ti), molybdenum (Mo), a stack layer of the above-mentioned materials, or an alloy of the above-mentioned materials, but the present invention is not limited to this and other appropriate conductive materials may also be employed. Additionally, the first connecting lines 212 may partially overlap the second axis electrodes 220, and the second connecting lines 232 may partially overlap the second axis electrodes 220. An insulating pattern (not shown) is preferably disposed in a region wherein the first connecting lines 212 partially overlap the second axis electrodes 220 and in a region wherein the second connecting lines 232 partially overlap the second axis electrodes 220. The insulating layer may be disposed between the first connecting lines 212 and the second axis electrodes 220 so as to electrically isolate the first connecting lines 212 and the second axis electrodes 220, the insulating layer may be disposed between the second connecting lines 232 and the second axis electrodes 220 so as to electrically isolate the second connecting lines 232 and the second axis electrodes 220, and the interference issue may be accordingly avoided.

The following description is based on different embodiments of the touch panel in the present invention. To simplify the description, the following description will focus on the differences among embodiments rather than similar parts. Furthermore, the same reference numbers are used in each description of embodiments for the convenience of cross-reference.

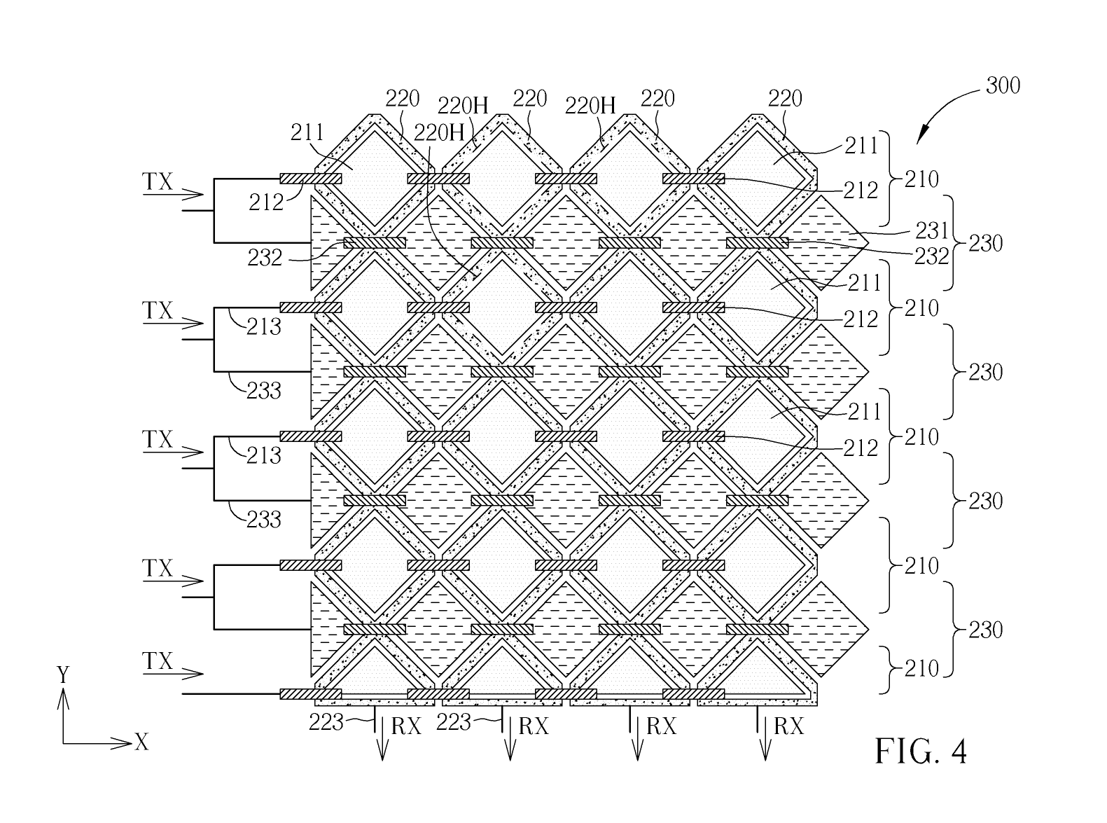

Please refer to FIG. 4. FIG. 4 is a schematic diagram illustrating a touch panel 300 according to a second preferred embodiment of the present invention. As shown in FIG. 4, the touch panel 300 includes a plurality of first axis electrodes 210 and a plurality of second axis electrodes 220. The difference between the touch panel 300 of this embodiment and the touch panel 200 of the first preferred embodiment is that, at least one of the first axis electrodes 210 is electrically connected to one adjacent third axis electrode 230 via the first signal line 213 and the third signal line 233. Accordingly, the first axis electrode 210 and the third axis electrode 230, which are electrically connected to each other, may be applied with the same touch driving signal TX. An amount of driving channels in a driving device (not shown) may be relatively decreased without affecting the performances such as the appearance quality improvement, the positioning accuracy enhancement, and the touch sensitivity enhancement mentioned above. The driving device may be accordingly simplified. Apart from the electrical connection between the first signal line 213 and the third signal line 233 in this embodiment and the method of applying the touch driving signal TX in this embodiment, the other components, allocations and material properties of this embodiment are similar to those of the first preferred embodiment detailed above and will not be redundantly described.

To summarize the above descriptions, in the touch panel of the present invention, the second axis electrodes, which are used to receive the touch receiving signals, are disposed in the spacing between the sensing electrodes, which are used to transmit the touch driving signals, so as to reduce the parasitic capacitance between the sensing electrodes and the second axis electrodes. The signal to noise ratio and the signal sensing density of the touch panel may be accordingly enhanced. Additionally, the signal sensing density of the touch panel is increased without changing the area of each of the sensing electrodes. The appearance quality may be enhanced by disposing the second axis electrodes in the spacing between the sensing electrodes.

Those skilled in the art will readily observe that numerous modifications and alterations of the device and method may be made while retaining the teachings of the invention.

What is claimed is:

1. A touch panel, comprising:
a plurality of first axis electrodes, extending along a first direction, wherein the first axis electrodes are disposed repeatedly along a second direction, and each of the first axis electrodes comprises a plurality of first sensing electrodes disposed along the first direction; and
a plurality of second axis electrodes, extending along the second direction, wherein the second axis electrodes are disposed repeatedly along the first direction, and each of the second axis electrodes surrounds the first sensing electrodes disposed along the second direction.

2. The touch panel of claim 1, wherein each of the second axis electrodes has a plurality of hollow regions disposed along the second direction, and each of the first sensing electrodes is disposed in the hollow region.

3. The touch panel of claim 1, wherein each of the first axis electrodes further comprises a plurality of first connecting lines to electrically connect the first sensing electrodes within one identical first axis electrode and transmit a touch driving signal, and a touch receiving signal is received from each of the second axis electrodes.

4. The touch panel of claim 1, further comprising a plurality of third axis electrodes extending along the first direction, wherein the third axis electrodes are disposed repeatedly along the second direction, and each of the third axis electrodes is disposed between two adjacent first axis electrodes.

5. The touch panel of claim 4, wherein each of the third axis electrodes comprises a plurality of second sensing electrodes disposed along the first direction, and each of the second sensing electrodes is disposed between two adjacent second axis electrodes.

6. The touch panel of claim 5, wherein each of the third axis electrodes further comprises a plurality of second connecting lines to electrically connect the second sensing electrodes within one identical third axis electrode and transmit a touch driving signal, and a touch receiving signal is received from each of the second axis electrodes.

7. The touch panel of claim 5, wherein the first sensing electrodes, the second sensing electrodes, and the second axis electrodes are made of an identical transparent conductive material.

8. The touch panel of claim 5, wherein an area of the first sensing electrodes and the second sensing electrodes is larger than an area of the second axis electrodes.

9. The touch panel of claim 4, wherein each of the first axis electrodes is electrically isolated from each of the third axis electrodes.

10. The touch panel of claim 4, wherein at least one of the first axis electrodes is electrically connected to one adjacent third axis electrode.
